(19) United States
(12) Patent Application Publication
(10) Pub. No.: US 2013/0192042 A1
(43) Pub. Date: Aug. 1, 2013

(54) ASSEMBLY DEVICE AND METHOD

(71) Applicants: Bin GUO, WuJiang Economic-Tech. Development Area (CN); Wei HUANG, WuJiang Economic-Tech. Development Area (CN); Ching-Feng HSIEH, Taipei (TW)

(72) Inventors: Bin GUO, WuJiang Economic-Tech. Development Area (CN); Wei HUANG, WuJiang Economic-Tech. Development Area (CN); Ching-Feng HSIEH, Taipei (TW)

(73) Assignees: ASKEY COMPUTER CORPORATION, New Taipei City (TW); ASKEY TECHNOLOGY (JIANGSU) LTD., Wuijiang Economic-Tech. Dev. Area (CN)

(21) Appl. No.: 13/450,846

(22) Filed: Apr. 19, 2012

(30) Foreign Application Priority Data
Feb. 1, 2012 (TW) 101103195

(51) Int. Cl. B23P 11/00; B23P 19/00

(52) U.S. Cl. 29/428; 29/700

(57) ABSTRACT

An assembly device for assembling a main body and an external chamber of a product includes: a base, laterally pressing units disposed on left and right sides of the base, and an actuator disposed on a rear side of the base. The external chamber of the product is positioned on the base. The laterally pressing units press an opening of the external chamber from left and right sides thereof so as to generate convex deformations on upper and lower sides of the opening. The actuator moves the main body towards the opening of the external chamber so as to dispose the main body in the external chamber. The invention avoids product damages, saves time and labor consumption, and improves the product yield.

### BACKGROUND OF THE INVENTION

1. Field of the Invention

The present invention relates to product assembling techniques, and, more particularly, to an assembly device and method for assembling a main body into an external chamber of a product.

2. Description of Related Art

In order to meet the waterproof and shock-resistant requirements of an electronic product, a frame-shaped foam 213, as shown in FIG. 1, is usually provided at the junction between a screen and an external chamber (i.e., a housing of the electronic product), which, however, results in a maximum interference of the design, complicates the product assembly, and reduces the production efficiency.

Conventionally, a main body of a product is manually assembled into an external chamber of the product through the following steps. First, a layer of mylar is disposed to the foam of the main body. The mylar has the same size as the planar size of the screen.

Then, an assembly person uses one hand to hold the external chamber with its opening facing up and uses the other hand to dispose the main body together with the layer of mylar into the external chamber. Finally, the assembly person pulls the layer of mylar out of the external chamber and examines whether the foam is crumpled. If the foam is not crumpled, the assembly person tightens screws outside the external chamber; otherwise, the assembly person repeats the above-described processes until the foam is not crumpled.

Such an assembly method is time-consuming and labor-consuming, and consequently leads to a low production efficiency. In addition, the foam is likely to be crumpled, thereby adversely affecting the assembly quality.

Therefore, how to overcome the above-described drawbacks becomes critical in the art.

### SUMMARY OF THE INVENTION

In view of the above-described drawbacks, an object of the present invention is to provide an assembly device and method so as to avoid product damages during the assembly process and improve the assembly quality.

Another object of the present invention is to provide an assembly device and method so as to save time and labor, thereby improving the production efficiency.

In order to achieve the above and other objects, the present invention provides an assembly device for assembling a main body into an external chamber of a product, which comprises: a base for positioning the external chamber; laterally pressing units disposed on left and right sides of the base for pressing an opening of the external chamber from left and right sides thereof; and an actuator disposed on a rear side of the base and movable towards the opening of the external chamber.

In an embodiment, the main body of the product can have a main board, a screen connected to the main board, and a frame-shaped foam attached to the screen.

In an embodiment, the external chamber of the product has an inverted trapezoidal structure.

In an embodiment, the assembly device further has a pneumatic unit for providing air pressure to the laterally pressing units or the actuator for operation,

In an embodiment, the assembly device further has a screw mechanism and a motor provided for operation of the laterally pressing units or the actuator.

In an embodiment, the assembly device further has a hand crank and a linkage mechanism provided for operation of the laterally pressing units or the actuator.

In an embodiment, the laterally pressing units are further provided with scale marks for facilitating adjustment of the positions of the laterally pressing units.

The present invention further provides an assembly method for assembling a main body and an external chamber of a product, which comprises the steps of: positioning the external chamber on a base; pressing an opening of the external chamber from left and right sides thereof so as to generate convex deformations on upper and lower sides of the opening; and moving the main body towards the opening of the external chamber so as to dispose the main body in the external chamber.

According to the present invention, the laterally pressing units press the opening of the external chamber from the left and right sides thereof so as to generate convex deformations on the upper and lower sides of the opening, thereby increasing the gap between the main body and the external chamber of the product. Therefore, the main body can be easily and conveniently assembled into the external chamber of the product without any crumpling occurring to the foam, thus improving the assembly quality, saving time and labor and increasing the production efficiency.

### BRIEF DESCRIPTION OF DRAWINGS

FIG. 1 is a schematic structural view of a main body of a product according to the present invention;

FIG. 2 is a schematic structural view of an external chamber of the product;

FIG. 3 is a schematic structural view of an assembly device according to the present invention;

FIG. 4 is a schematic structural view showing the assembly device in combination with a product; and

FIG. 5 is a flow diagram showing an assembly method according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

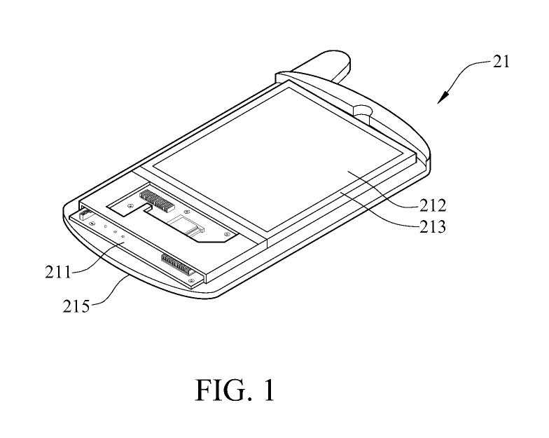

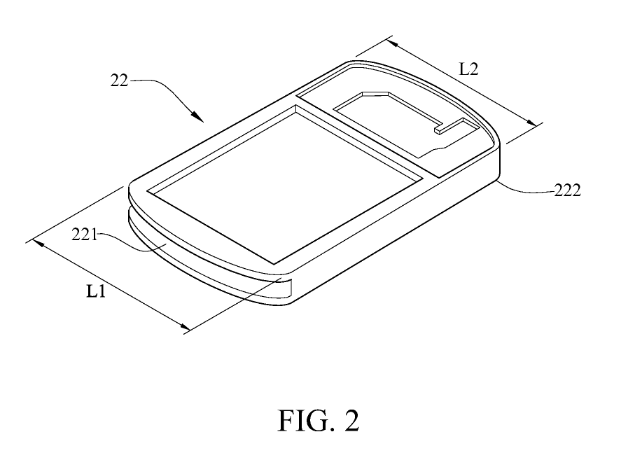

Referring to FIGS. 1 and 2, the present invention provides an assembly device for assembling a main body 21 and an external chamber 22 having an opening 221. The main body 21 is inserted into the opening 221 of the external chamber 22 through the bottom 215 thereof. Referring to FIG. 1, the main body 21 has a main board 211, a screen 212 connected to the main board 211, and a frame-shaped foam 213 attached around the periphery of the screen 212 (also referred as a first region). Referring to FIG. 2, the external chamber 22 has an inverted trapezoidal structure. That is, the length L1 of the opening 221 is greater than the length L2 of the bottom 222.

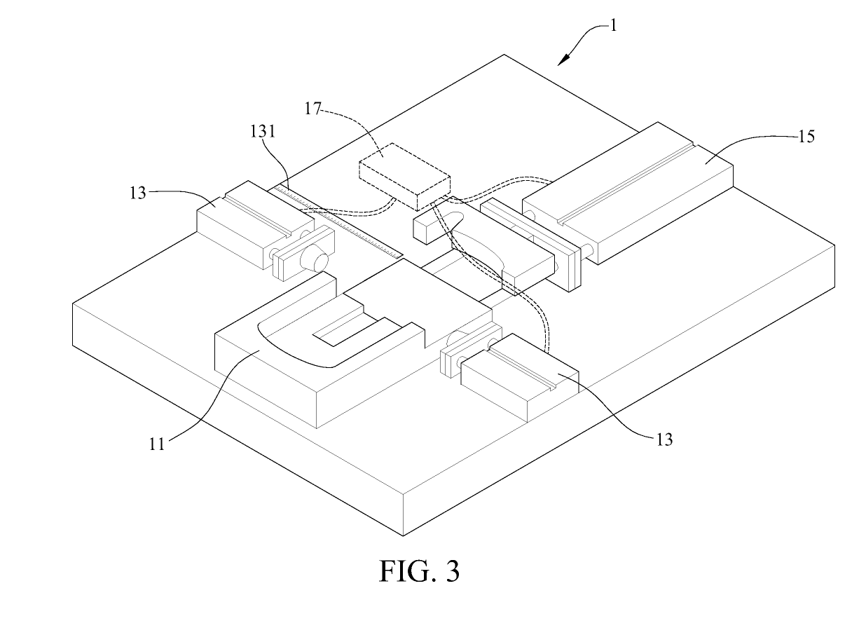

FIG. 3 shows the structure of the assembly device 1 according to the present invention. The assembly device 1 has a base 11, laterally pressing units 13, and an actuator 15.

The base 11 is used for positioning the external chamber 22 of the product.

The laterally pressing units 13 are disposed on left and right sides of the base 11 and movable towards each other so as to press the opening 221 of the external chamber 22 from left and right sides thereof, thereby generating convex deformations on upper and lower sides of the opening 221. Therefore, the gap between the main body 21 and the external chamber 22 is increased. In an embodiment, the laterally pressing units 13 are further provided with scale marks 131 for facilitating adjustment of the positions of the laterally pressing units 13. As such, the laterally pressing units 13 can be positioned symmetrically to each other so as for the opening 221 of the external chamber 22 to have an optimal deformation, thereby facilitating the subsequent assembly process.

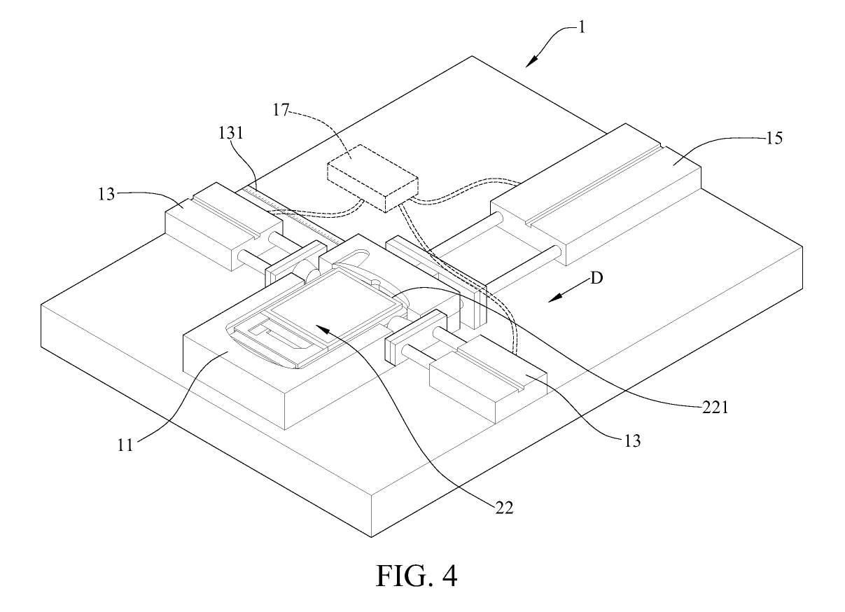

The actuator 15 is disposed on a rear side of the base 11 and movable towards the opening 221 along a direction D of FIG. 4 so as to push the main body 21 into the external chamber 22.

Furthermore, a pneumatic unit 17 can be connected to the laterally pressing units 13 and/or the actuator 15 so as to provide air pressure to the laterally pressing units 13 and/or the actuator 15 for operation. Alternatively, the pneumatic unit 17 can be replaced by a screw mechanism and a motor, or replaced by a hand crank and a linkage mechanism

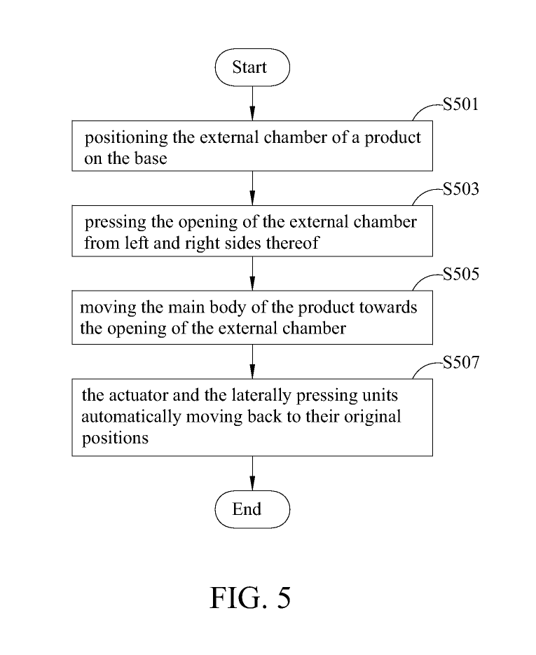

FIG. 5 shows an assembly method according to the preset invention.

Referring to FIG. 5 in combination with FIG. 4, at step S501 the external chamber 22 of a product is positioned on the base 11 of the assembly device 1. Then, the method goes to step S503.

At step S503, the laterally pressing units 13 are moved towards each other so as to press the opening 221 of the external chamber 22 from left and right sides thereof, thereby generating convex deformations on upper and lower sides of the opening 221. Then, the method goes to step S505.

At step S505, the actuator 15 is operated to move the main body 21 towards the opening 221 of the external chamber 22 so as to dispose the main body 21 in the external chamber 22. Then, the method goes to step S507.

At step S507, after the main body 21 is disposed in the external chamber 22, the actuator 15 and the laterally pressing units 13 automatically move back to their original positions.

According to the present invention, the opening of the external chamber of a product is pressed to generate convex deformations on upper and lower sides thereof to thereby increase the gap between the main body and the external chamber of the product. Consequently, the main body can be easily and conveniently assembled into the external chamber of the product without any crumpling occurring to the foam, thereby improving the assembly quality, saving time and labor and increasing the production efficiency.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An assembly device for assembling a main body into an external chamber of a product, the assembly device comprising:
a base for positioning the external chamber;
laterally pressing units disposed on left and right sides of the base for pressing an opening of the external chamber from left and right sides thereof; and
an actuator disposed on a rear side of the base and movable towards the opening of the external chamber.

2. The assembly device of claim 1, wherein the main body of the product comprises a main board, a screen connected to the main board, and a frame-shaped foam attached to the screen.

3. The assembly device of claim 1, wherein the external chamber of the product has an inverted trapezoidal structure.

4. The assembly device of claim 1, further comprising a pneumatic unit for providing air pressure to the laterally pressing units or the actuator for operation.

5. The assembly device of claim 1, further comprising a screw mechanism and a motor provided for operation of the laterally pressing units or the actuator.

6. The assembly device of claim 1, further comprising a hand crank and a linkage mechanism provided for operation of the laterally pressing units or the actuator.

7. The assembly device of claim 1, wherein the laterally pressing units are further provided with scale marks for facilitating adjustment of the positions of the laterally pressing units.

8. An assembly method for assembling a main body into an external chamber of a product, the assembly method comprising the steps of:
positioning the external chamber on a base;
pressing an opening of the external chamber from left and right sides thereof so as to generate convex deformations on upper and lower sides of the opening; and
moving the main body towards the opening of the external chamber so as to dispose the main body in the external chamber.

9. The assembly method of claim 8, wherein the main body of the product comprises a main board, a screen connected to the main board, and a frame-shaped foam attached to the screen.

10. The assembly method of claim 8, wherein the external chamber of the product has an inverted trapezoidal structure.
